(19) United States
(12) Patent Application Publication
(10) Pub. No.: US 2006/0075098 A1
(43) Pub. Date: Apr. 6, 2006

(54) Protocol for adapting the degree of interactivity among computer equipment items

(76) Inventors: Claudia Becker, Rennes (FR); Andre Codet, Rennes (FR); Pierre Fevrier, Saint Sulpice La Foret (FR); Chantal Guionnet, Cesson Sevigne (FR)

Correspondence Address: STITES & HARBISON PLLC, 1199 NORTH FAIRFAX STREET, SUITE 900, ALEXANDRIA, VA, 22314, US

(21) Appl. No.: 10/518,901

(22) PCT Filed: Jun. 25, 2003
(86) PCT No.: PCT/FR03/01964

§ 371 Date: Dec. 23, 2004

(30) Foreign Application Priority Data
Jun. 26, 2002 (FR) 02/07954

(51) Int. Cl. G06F 15/173

(52) U.S. Cl. 709/225; 709/227

(57) ABSTRACT

The invention concerns a protocol for adapting the degree of interactivity among computer equipment items (A, B), which consists in writing, in an initiating participant equipment item (A), a list (L_ID_{A}) of identifiers of reciprocal responding participant equipment items (B), a list of behaviour identifiers (L_CA), at least one association between an equipment identifier and a behaviour identifier. When the participant equipment (A) and the reciprocal participant equipment (B) are in each other's presence, it further consists in carrying out a procedure (1) of authentication between them and in searching for (2) the identifier of the reciprocal participant equipment (B) in the list of identifiers (L_ID_{A}), reading (4) the associated behaviour identifier and applying (5), at the participant equipment (A), the behaviour relative to the reciprocal participant equipment (B), said behaviour being determined on the basis of the result of the authentication procedure. The invention is useful for adapting or matching interactivity of computer equipment items interconnected through the network in accordance with IP protocol or connected in accordance with the ISO 7816 protocol.

The invention relates to a protocol for adapting the degree of interactivity between participant computer equipment items that are subjected to an interactive dialogue.

Currently used methods for exchanging information between computer terminals require the most advanced authentication protocols to be used, in order to provide these exchanges with a high degree of security.

Protocols of this type generally allow almost complete certainty as to the origin of the received information, without, however, using knowledge relating to the intrinsic qualities of the emitters of said information, or of the user or users of these emitters.

Specific computer equipment items, such as a terminal provided with a microprocessor card reader and a microprocessor card, in particular a descrambling terminal, also known as a decoder, and a card associated with said terminal, are, at best, capable of proposing an adaptation of the behavior of one of the equipment items as a function of specific qualities of the other of these equipment items, with which this equipment item enters into contact.

In this situation, only the terminal is capable of adapting its behavior, relative to the card, when it is brought into contact with a card, as a function of the connected card type.

The aforementioned adaptation is implemented by the terminal reading, in the memory of the card, information specific to the card.

The object of the present invention is to solve the drawbacks of the known prior art and, in particular, to allow adaptation of the behavior of at least one of the equipment items, either by authorization, or by prohibition or else by conditional authorization, of internal functions of each equipment item, as a function of the identification of the equipment item connected thereto.

In particular, the present invention relates to the use of an adaptive behavior of each interconnected computer equipment item, in an interactive dialogue, following a procedure of reciprocal authentication between computer equipment items, in order to implement an intercommunication procedure at a high level of security in the exchange of information, owing to the reciprocal authentication procedure used, on the one hand, and the reciprocal behavior adaptation procedure, on the other hand, of each equipment item.

The protocol for adapting the degree of interactivity between a participant computer equipment item and a reciprocal participant computer equipment item of a set of participant equipment items, which is the subject of the present invention, is implemented when this participant equipment item and this reciprocal participant equipment item are subjected to an interactive dialogue.

It is notable in so far as it consists in writing, into this participant equipment item, a list of identifiers of reciprocal participant equipment items, in writing, into this participant equipment item, a list of behavior identifiers, these behaviors being relevant in the interactive dialogue, and in writing, into this participant equipment items, at least one association between an equipment identifier and a behavior identifier.

When a participant equipment item and a reciprocal participant equipment item are in each other's presence, in order to execute the interactive dialogue, the protocol according to the present invention also consists in carrying out a procedure of authentication between the participant equipment item and the reciprocal participant equipment item, and in searching for the identifier of the authenticated reciprocal participant equipment item in the list of identifiers, in reading the associated behavior identifier, in applying, at the participant equipment item, the behavior or behaviors relative to the authenticated reciprocal participant equipment item, this behavior being selected as a function of the result of the authentication procedure and associated with the behavior identifier and with the identifier of the reciprocal participant equipment item.

The computer equipment item, in accordance with the subject of the present invention, comprises an input/output circuit allowing messages to be transmitted and/or received in an interactive dialogue with another computer equipment item, a calculation module connected to the input/output circuit, a working random access memory and at least one programmable, non-volatile memory,

It is notable in so far as it comprises, written into the non-volatile memory, at least a list of computer equipment item identifiers, accessible via the input/output circuit, a list of behavior identifiers that are relevant in the interactive dialogue, and at least one association between an equipment identifier and a behavior identifier.

The protocol and the computer equipment item that are the subjects of the present invention are used in order to render network transactions secure and, in particular, in station-to-station or multistation transactions, for terminals forming these equipment items interconnected in a network in accordance with the IP protocol, and in transactions between a microprocessor card reading terminal and a microprocessor card, interconnected in accordance with the ISO 7816 protocol, for example.

A better understanding of the protocol and the computer equipment item will be facilitated by reading the description and viewing the following drawings, in which:

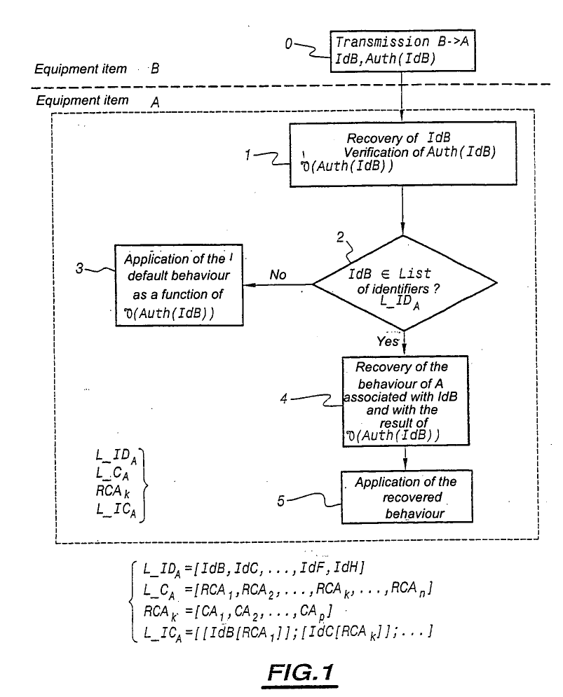

FIG. 1 shows, by way of example, a flow chart of the implementation of the protocol according to the present invention, between a computer equipment item, serving as a participant equipment item, and another computer equipment item, provided in order to execute an interactive dialogue, this other equipment item serving, relative to this participant equipment item, as a reciprocal participant equipment item prior to the actual execution of this interactive dialogue, at least one of these computer equipment items adapting the degree of interactivity of this interactive dialogue relative to this other computer equipment item, in accordance with the protocol according to the present invention;

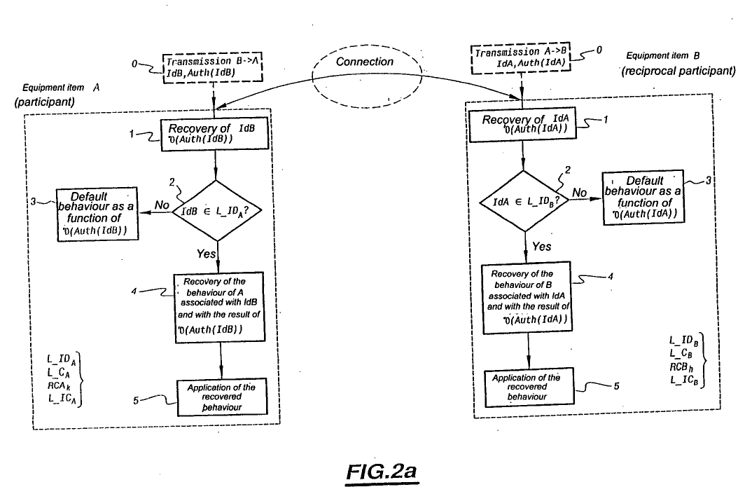

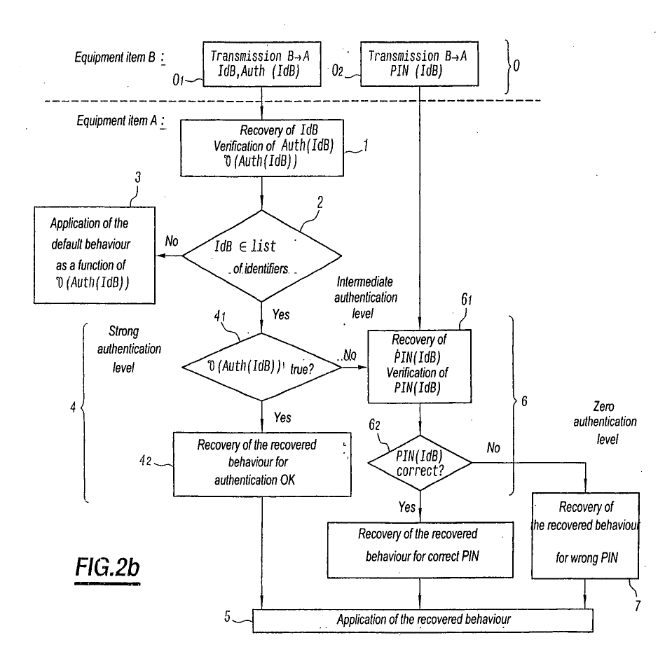

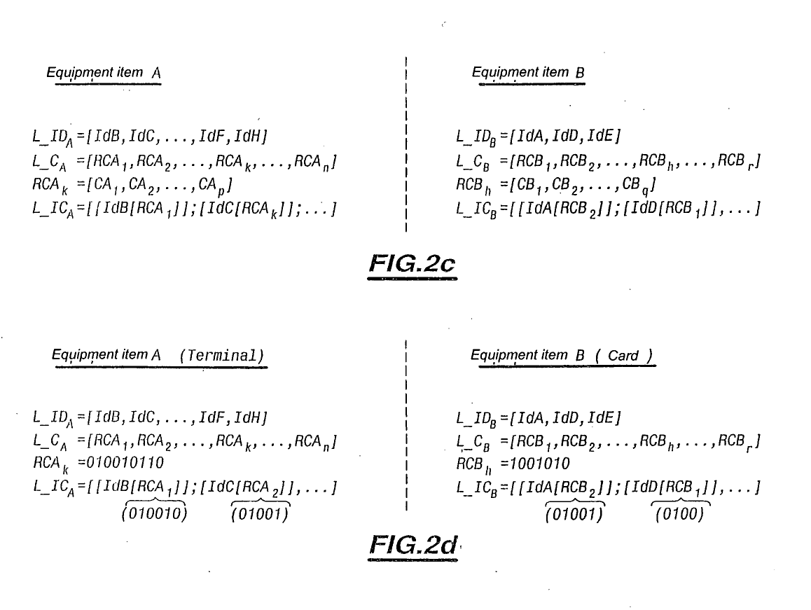

FIG. 2a shows, by way of example, a flow chart of the implementation of the protocol according to the present invention, between a computer equipment item, serving as a participant equipment item, and another computer equipment item, provided in order to execute an interactive dialogue, this other equipment item serving, relative to this participant equipment item, as a reciprocal participant equipment item prior to the actual execution of this interactive dialogue, each of these computer equipment items adapting the degree of interactivity of this interactive dialogue relative to this other computer equipment item, the adaptations of the degree of interactivity of each computer equipment item relative to this other computer equipment item being independent, but related to the identity of the computer equipment item provided in order to execute this interactive dialogue, all of the computer equipment items provided executing, in accordance with the protocol according to the present invention, a reciprocal adaptation of the interactivity of this interactive dialogue;

FIG. 2b shows, purely by way of example, a preferred, non-limiting embodiment of the protocol according to the present invention, in which the authentication procedure is a procedure at more than one authentication level, in order to allow adaptation of the behaviors associated with the participant equipment item and/or with the reciprocal participant equipment item, as a function of the verified authentication level;

FIG. 2c shows, by way of example, a first, non-limiting embodiment of a list of equipment identifiers, a list of behavior identifiers and a list of associations between an equipment identifier and a behavior identifier for a first computer equipment item, equipment item A, and a second computer equipment item, equipment item B, one of these computer equipment items serving as a participant equipment item and the other of these computer equipment items serving as a reciprocal participant equipment item, wherein the interactive dialogue between these computer equipment items may itself be conducted by means of an IP protocol, by way of non-limiting example;

FIG. 2d shows, by way of example, a second, non-limiting embodiment of a list of equipment identifiers, a list of behavior identifiers, and a list of associations between an equipment identifier and a behavior identifier for a first computer equipment item, formed by a terminal, and a second computer equipment item, formed by a microprocessor card, the terminal forming the first computer equipment item being provided with a card reading device, and the terminal and the card executing the interactive dialogue in accordance with the ISO 7816 protocol, for example;

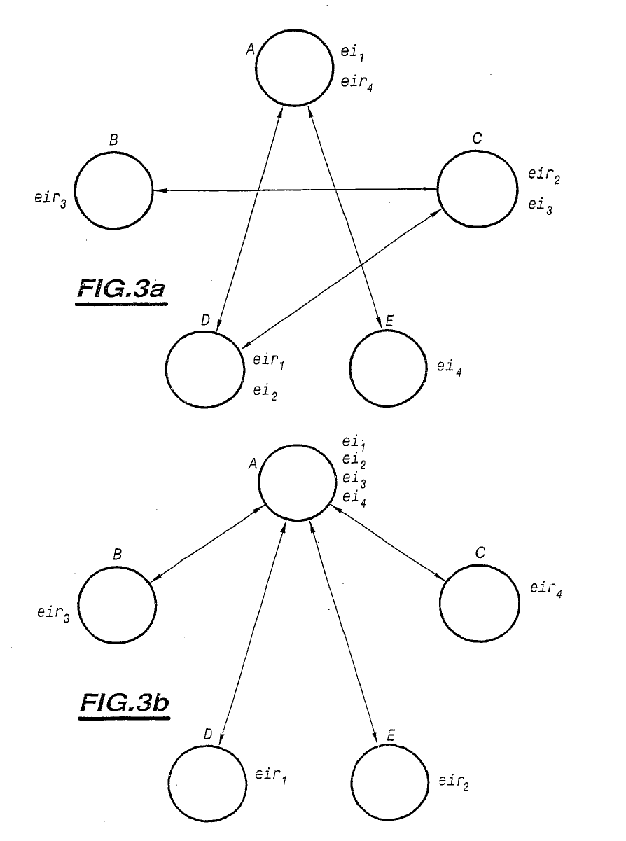

FIG. 3a shows, by way of example, a particular embodiment of the protocol according to the present invention for a set of computer equipment items interconnected in a network, each equipment item being capable of executing an interactive dialogue with one of the other computer equipment items of this set of equipment items, the protocol according to the present invention being implemented, as shown in FIG. 2a, by means of pairs of equipment items, to which the roles of participant and reciprocal participant, respectively, have been attributed;

FIG. 3b shows, by way of example, a particular embodiment of the protocol according to the present invention for a set of computer equipment items, one of the equipment items serving as a participant equipment item, such as a terminal, and each of the other equipment items serving as a reciprocal participant, such as a card, relative to this participant equipment item:

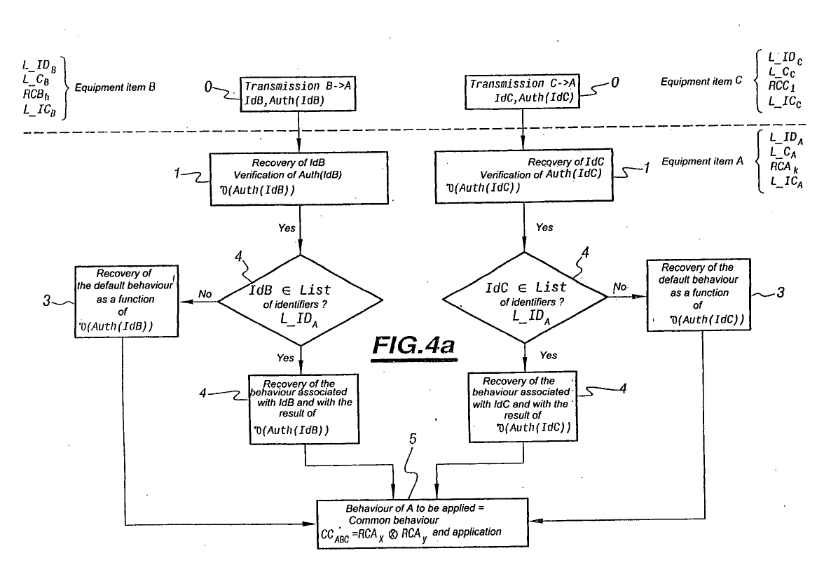

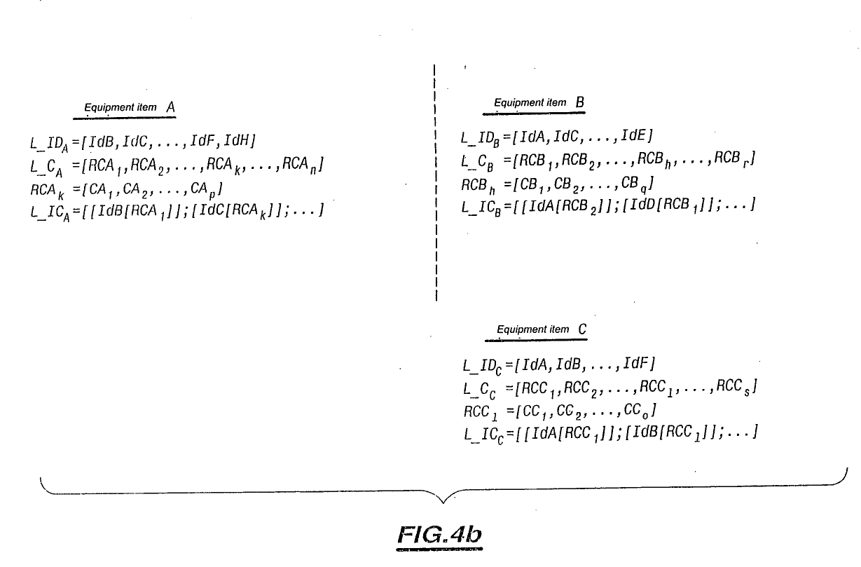

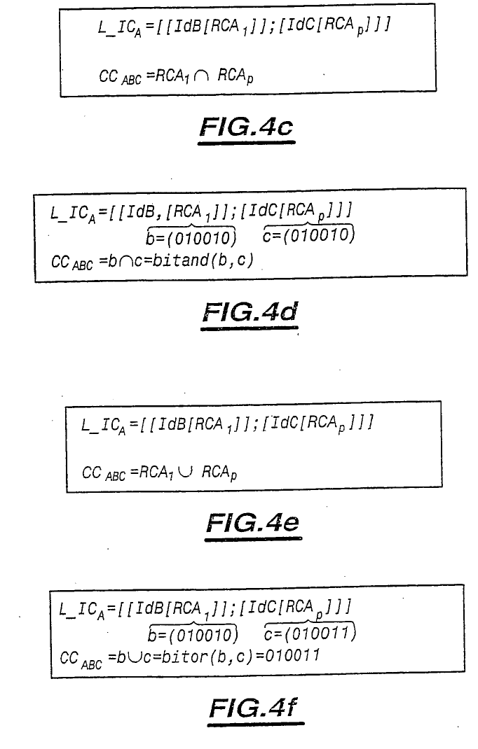

FIG. 4a shows, by way of example, another particular embodiment of the protocol according to the present invention for a set of computer equipment items interconnected in a network, each equipment item being capable of executing an interactive dialogue with one of the other computer equipment items of this set of equipment items, the protocol according to the present invention being implemented so as to apply a common behavior of any equipment items of this set of equipment items relative to other equipment items of this set of equipment items, wherein the common behavior may correspond to a list resulting from a logical operation carried out on lists of behaviors of the equipment item in question;

FIG. 4b shows, purely by way of example, embodiments of a list of equipment identifiers, a list of behavior identifiers and a list of associations between an equipment identifier and a behavior identifier for the execution of the protocol according to the present invention, in accordance with the embodiment of FIG. 4a;

FIGS. 4c and 4d illustrate purely by way of example, a mode for calculating the resulting list, the intersection of lists of behavior identifiers, for computer equipment items connected in a network for a terminal provided with a card reader and two separate cards, respectively;

FIGS. 4e and 4f illustrate purely by way of example, a method of calculating the resulting list, the union of lists of behavior identifiers, for computer equipment items connected in a network for a terminal provided with a card reader and two separate cards, respectively;

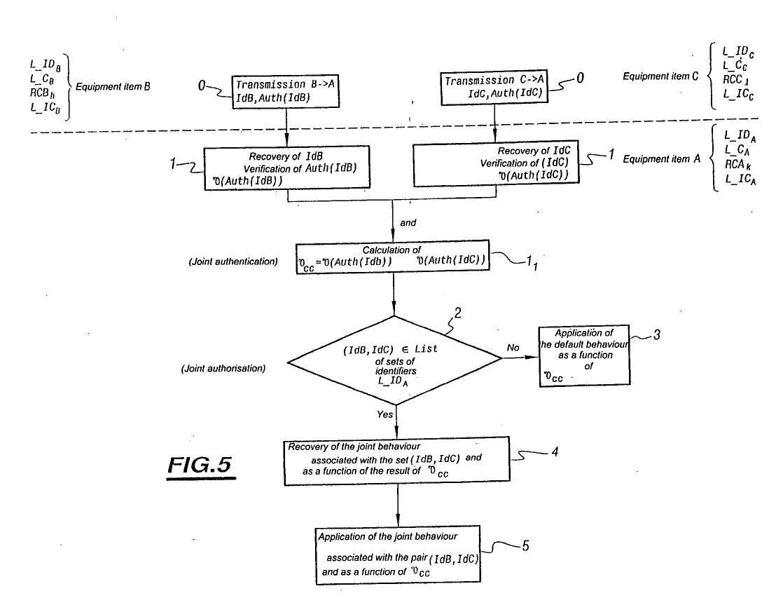

FIG. 5 shows, by way of example, another particular embodiment of the protocol according to the present invention for a set of computer equipment items interconnected in a network, each equipment item being capable of executing an interactive dialogue with one of the other computer equipment items of this set of equipment items, the protocol according to the present invention being implemented so as to apply a joint behavior of any equipment items of this set of equipment items relative to other equipment items of this set of equipment items, wherein the joint behavior may correspond to an adaptation of the interactivity of each computer equipment item relative to the subset, of the other computer equipment items of this set of computer equipment items, according to which adaptation, the subset of the other computer equipment items is established, from the point of view of interactivity, as a single reciprocal participant relative to this computer equipment item.

A more detailed description of the protocol for adapting the degree of interactivity between computer equipment items according to the present invention will now be given with reference to FIG. 1.

Referring to the aforementioned figure, it is mentioned that the protocol according to the invention is intended to be implemented between two or more computer equipment items of a set of computer equipment items.

In general it is mentioned, in the implementation of the protocol according to the present invention, that the term “participant equipment item” refers to any computer equipment item of this set of equipment items that initiates an interactive dialogue with another equipment item of this set of computer equipment items. For this reason, the other computer equipment item is referred to as a “reciprocal participant equipment item”, in this interactive dialogue.

Referring to the aforementioned FIG. 1, it is mentioned that equipment item A is referred to as a “participant equipment item” and that the equipment B is referred to as a “reciprocal participant equipment item”, with reference to the aforementioned definition.

The aim of the protocol according to the present invention is, in particular, to adapt the degree of interactivity between the participant equipment item and the aforementioned reciprocal participant equipment item, when the participant equipment item and the reciprocal participant equipment item are subjected to the aforementioned interactive dialogue.

Referring to FIG. 1, it is mentioned that the protocol according to the invention consists in writing, into the participant equipment item, a list of identifiers of reciprocal participant equipment items and a list of behavior identifiers, these behaviors being relevant in the interactive dialogue.

The protocol according to the invention also consists in writing, into the participant equipment item, equipment item A, at least one association between an equipment identifier and a behavior identifier. The aforementioned association may itself be formed by a list of association.

The notion of a list of equipment identifiers, such as the aforementioned list of identifiers of reciprocal participant equipment items, encompasses all references to a given individual equipment item or to a class or defined set of equipment items, by way of a version, production or sale trademark, certification, authorization or other reference.

Following the aforementioned writing operations, the participant equipment item at least has a set of lists: the aforementioned list of identifiers of reciprocal participant equipment items, list of behavior identifiers and list of associations.

It will obviously be understood that the steps of writing the list of identifiers of reciprocal participant equipment items, the list of behavior identifiers and the list of associations are carried out at least once, in order to implement the protocol according to the present invention, and may obviously be repeated in order to update the equipment and/or behavior identifiers and the list of association between equipment identifier and a behavior identifier, as will be described below.

The writing operations are carried out in a secure manner.

Referring to FIG. 1, it is mentioned, by way of non-limiting example, that the participant equipment item, equipment item A, at least has a list of identifiers of reciprocal participant equipment items, the list L_ID_{A} representing the plurality of these identifiers, this list confirming the equation:
L_ID_{A}=[IdB,IdC, . . . ,IdH]
wherein Id_{B} to Id_{H} are said each to denote an identifier of reciprocal participant equipment items.

Moreover, the participant equipment item A has a list of behavior identifiers, denoted by L_C_{A}, confirming the equation:
L_C_{A=[RCA}₁,RCA₂ . . . ,RCAₖ, . . . RCAₙ].

In the list of behavior identifiers, L_C_{A}, RCA_{K} designates an identifier of specific behaviors of the participant equipment item A relative to the reciprocal participant equipment item, equipment item B.

By way of non-limiting example, it is mentioned that each behavior identifier RCAₖ may itself be formed by a list of elementary behaviors also known as behavior references, each behavior identifier RCA_{K} confirming the equation:
RCAₖ=[CA₁,CA₂, . . . ,CAₚ].

By way of non-limiting example, it is mentioned that the elementary behavior or behavior references CAₚ may correspond to behavior reference codes as will be described below.

Finally, the participant equipment item A has a list of associations between an equipment identifier and a behavior identifier, the aforementioned list of associations being denoted by L_IC_{A} and confirming the equation:
L_IC_{A}=[[IdB[RCA₁]];[IdC[RCAₖ]]; . . . ].

The form of construction or structure of the list of associations is non-limiting.

In particular, it will be understood from FIG. 1 that each identifier IdB or IdC, or otherwise, is associated with a behavior identifier, i.e. the behavior RCA₁ relative to the identifier IdB, the behavior RCAₖ relative to the identifier IdC, and so on.

In view of the existence of the lists of equipment identifiers, the list of behavior identifiers and the list of associations, the protocol according to the present invention consists primarily in carrying out a procedure of authentication between the participant equipment item A and the reciprocal participant equipment item B.

It is noted from FIG. 1 that the aforementioned authentication procedure may consist, for example, in a conventional, known manner and as such, following the emission of an interactive dialogue query emitted by equipment item A, the participant equipment item, to equipment item B, the reciprocal participant equipment item, in transmitting, from the reciprocal participant equipment item B to the participant equipment item A, not only the identifier IdB of the reciprocal participant equipment item B, but also authentication values of the reciprocal participant equipment item B relative to the participant equipment item A.

The aforementioned authentication values are denoted by Auth(IdB).

The authentication procedure, at the participant equipment item A, then consists, as shown in FIG. 1, in recovering, in step 1, the identifier IdB of the reciprocal participant equipment item B and also obviously in confirming the authentication values Auth(IdB) communicated by the reciprocal participant equipment item B. The verification of the authentication values is denoted by:
δ(Auth(IdB)).

The step of recovering the identifier IdB and confirming the authentication values Auth(IdB) may consist, as shown in FIG. 1, in confirming the authentication values Auth(IdB) communicated by the reciprocal participant equipment item B. This step may provide an authentication procedure result corresponding to various authentication levels, as will be described below.

Following step 1 and after verification of the aforementioned authentication values, the protocol according to the invention may consist, in a test step 2, in searching for the identifier of the reciprocal participant equipment item in the list of equipment identifiers, i.e. in the aforementioned list L_ID_{A}.

In the event of a negative response to the test step 2, wherein the identifier IdB is not found in the list of identifiers L_ID_{A}, for example, the protocol according to the invention may consist, in a step 3, in having the participant equipment item A apply what is known as a “default” behavior relative to the reciprocal participant equipment item B. The aforementioned default behavior may advantageously be established and selected as a function of the result of the authentication procedure, in particular, of the confirmed authentication level.

By way of non-limiting example, it is mentioned that, although the authentication has been established for a given authentication level, the authentication values Auth(IdB) having been confirmed for the level in question, the protocol according to the invention may consist in sending a query from the participant equipment item A to the reciprocal participant equipment item B, so that said reciprocal participant equipment item B retransmits its equipment identifier value IdB, for example. Other procedures may be provided, such as the attribution, for example, in the single transaction, of a replacement identifier associated with the aforementioned authentication values Auth(IdB) and at the aforementioned authentication level.

In the event of a positive response to the step of test 2, the procedures of authentication and identification of the reciprocal participant equipment item B having been satisfied relative to the participant equipment item A, the protocol according to the invention may consist in recovering the behavior associated with the equipment identifier found and with the result of the authentication procedure. This operation is carried out in step 4 in FIG. 1.

The aforementioned step 4 may then be followed by a step 5, consisting in applying at the participant equipment item A the behavior relative to the reciprocal participant equipment item.

Referring to FIG. 1, it will be understood that in the event of a positive response to the test 2 of the affiliation of the identifier IdB to the list of equipment identifiers L_ID_{A}, for example, the operations 4 and 5 may then be implemented by reading the behavior identifier. This operation is carried out by selection of the first member of list [IdB[RCA₁]] of the aforementioned list of associations L_IC_{A} and obviously reading of the behavior found, i.e. the behavior identifier RCA₁, then reading of the elementary behaviors, as defined by the behavior identifier RCA₁.

Referring to FIG. 1, it is mentioned that the protocol according to the present invention allows the degree of interactivity of the participant equipment item A to be adapted relative to the reciprocal participant equipment item B.

In particular, it will be understood that this result is obtained owing to the implementation of the aforementioned list of equipment identifiers L_ID_{A}, list of behavior identifiers L_C_{A} and list of associations between an equipment identifier and a behavior identifier L_IC_{A}, or by any corresponding data structure other than a list, allowing equipment identifiers, behavior identifiers and behavior references or elementary behaviors to be distinguished, as previously mentioned in the description.

In particular, it will obviously be understood that any behavior identifier RCAₖ formed by a plurality of coded values, each representative of an elementary behavior, such as CA₁, CA₂ . . . ,CAₚ, may be defined as a function of functional and/or technical specificities, i.e. reaction capacities of the reciprocal participant equipment item B, in the aforementioned interactive dialogue. This is the case, in particular, for each aforementioned coded value of elementary behavior, which behavior may be adapted to the technical/functional parameters of the reciprocal participant equipment item B or, if appropriate, to the reaction capacities of the reciprocal participant equipment item B, or even to the use of these technical/functional capacities by the authorized user of the aforementioned reciprocal participant equipment item B.

In a simplified, non-limiting embodiment, it is mentioned that the list of associations L_IC_{A} may be replaced by bi-unique matching of an equipment identifier and a behavior identifier by the rank of the equipment identifier and the rank of the behavior identifier in the list of equipment identifiers L_ID_{A} and the list of behavior identifiers L_CA, for example.

The protocol according to the present invention is not limited to an adaptation of the degree of interactivity between a participant equipment item and a reciprocal participant equipment item, as previously described with reference to FIG. 1.

According to another, particularly notable aspect of the protocol according to the present invention, said protocol allows the adaptation of the degree of interactivity between a participant equipment item A and a reciprocal participant equipment item B in all sets of computer equipment items, each of the participant equipment items A and reciprocal participant equipment items B respectively, implementing, in a substantially independent manner, the protocol of adaptation of the degree of interactivity of one participant equipment item relative to the other, which allows the implementation of a reciprocal adaptation protocol of the interactivity between a participant equipment item and a reciprocal participant equipment item of a set of participant equipment items subjected to an interactive dialogue, as will now be described with reference to FIG. 2a.

FIG. 2a therefore shows a participant equipment item, equipment item A, and a reciprocal participant equipment item, equipment item B.

For each of the aforementioned equipment items, i.e. the participant equipment item A and the reciprocal participant equipment item B, the protocol according to the invention obviously consist in carrying out the steps of writing into the participant equipment item A and into the reciprocal participant equipment item B, respectively, a plurality of identifiers of reciprocal participant equipment items and participant equipment items, respectively.

It will therefore be understood that the participant equipment item A has the list of identifiers of reciprocal participant equipment items L_ID_{A} and that the reciprocal participant equipment item B, for its part, has a list of identifiers of participant equipment items L_IDB.

The protocol according to the invention also consists in writing, into each participant equipment item, equipment item A, and into the reciprocal participant equipment item B, respectively, a list of behavior identifiers, the behaviors being relevant in the interactive dialogue.

Referring to FIG. 2a, it will be understood that the participant equipment item A comprises the list of behaviors L_C_{A} and that the reciprocal participant equipment item B comprises a list of behaviors L_C_{B}.

The protocol according to the invention also consists in writing a list of associations between an equipment identifier and a behavior identifier into each participant equipment item A and each reciprocal participant equipment item B. Under these conditions, referring to FIG. 2a, it is mentioned that the participant equipment item A has the list of associations L_IC_{A} and that the reciprocal participant equipment item has a list of associations L_IC_{B}.

For each participant equipment item and reciprocal participant equipment item, respectively, it will be recalled that the behavior identifiers of the lists of behavior identifiers L_C_{A} and L_C_{B} are denoted by RCAₖ and RCBₕ, respectively, for example.

When a participant equipment item A and a reciprocal participant equipment item B provided with all of the aforementioned lists are in each other's presence, in order to execute the interactive dialogue mentioned above in the description, the protocol according to the present invention consists in carrying out a procedure of reciprocal authentication between the participant equipment item A and the reciprocal participant equipment item B.

Generally, it is mentioned that the reciprocal authentication procedure may consist, in the event of the participant equipment item A requesting an interactive dialogue, in:
the transmission from the reciprocal participant equipment item B to the participant equipment item A of the identifier IdB and the authentication values Auth(IdB), as previously mentioned in the description, in relation to the implementation of the protocol according to the invention, described with reference to FIG. 1, and in
the transmission from the participant equipment item A to the reciprocal participant equipment item B of the identifier IdA and the authentication values Auth(IdA).

It is mentioned that the aforementioned operations of transmission of the identifiers and authentication values are carried out independently, wherein the transmission of the equipment identifier IdA and the authentication values Auth(IdA), by the participant equipment item A to the reciprocal participant equipment item B, may be carried out either prior to the implementation of step 1, involving the recovery and verification of authentication values Auth(IdB) of the reciprocal participant equipment item B by the participant equipment item A, or subsequently to this verification and conditionally thereon.

In the former case, the authentication procedures are independent and the protocol according to the present invention, of adapting the interactivity of the participant equipment item A relative to the reciprocal participant equipment item B, may be rendered completely independent of the protocol for adapting the interactivity of the reciprocal participant equipment item B relative to the participant equipment item A, or vice versa.

Following the transmission steps, bearing the reference numeral 0, for each of the participant equipment item A and the reciprocal participant equipment item B, respectively, each of these equipment items implements step 1, of recovering the identifier IdB of the reciprocal participant equipment item B, for the participant equipment item A, and of the identifier IdA of the participant equipment item A, respectively, for the reciprocal participant equipment item B, and of confirming the authentication δ(Auth(IdB)), δ(Auth)IdA)) of the authentication data Auth(IdB) and Auth(IdA), respectively, for the participant equipment item A and the reciprocal participant equipment item B, respectively.

Following step 1, and after verification of the aforementioned authentication values, the participant equipment item A and the reciprocal participant equipment item B implement step 2, of confirming the affiliation of the identifier of the reciprocal participant equipment item B and the participant equipment item A, respectively, i.e. IdB and IdA, respectively, to the list of identifiers possessed by the participant equipment item A and the reciprocal participant equipment item B, respectively.

The tests of step 2 verify respectively the following equations:
IdBεL_ID_{A}?
IdAεL_ID_{B}?

In the event of a negative response to the affiliation test 2, the participant equipment item A and the reciprocal participant equipment item B, respectively, may call a default behavior procedure 3, which may correspond to that defined above in the description referring to FIG. 1.

In the event of a positive response to the affiliation test 2, the participant equipment item A and the reciprocal participant equipment item B, respectively, may call procedure 4, involving the recovery of the behavior of the participant equipment item A relative to the identifier IdB and of the reciprocal participant equipment item B, and the recovery of the behavior of the reciprocal participant equipment item B relative to the identifier IdA and the participant equipment item A, respectively, and then, finally, step 5, involving the application of the behavior associated with the reciprocal participant equipment item B by means of the equipment identifier IdB and with the participant equipment item A by means of the equipment identifier of this IdA, respectively. As in the case of FIG. 1, these behaviors are associated not only with the corresponding equipment identifier, but also with the effectively confirmed authentication level.

It will be understood, in particular, that steps 4, involving the recovery of the behavior of the participant equipment item A relative to the reciprocal participant equipment item B and of the behavior of the reciprocal participant equipment item B relative to the participant equipment item A, respectively, are implemented by identifying the identifiers IdB of the reciprocal participant equipment item B and the identifier IdA of the participant equipment item A, respectively, and reading the corresponding behavior identifiers in the lists of associations L_IC_{A} and L_IC_{B}, respectively, as mentioned above in the description referring to FIG. 1.

A preferred, non-limiting embodiment of the protocol according to the present invention will now be described with reference to FIG. 2b, wherein the procedure of authentication between the participant equipment item and the reciprocal participant equipment item is a procedure at more than one authentication level.

It will be understood, in particular, that an implementation of this type allows adaptation of the behaviors associated with the participant equipment item and/or with the reciprocal participant equipment item as a function of the confirmed authentication level during the authentication procedure implemented either according to FIG. 1 or according to FIG. 2a.

In FIG. 2b, the same steps have the same reference numerals as in FIG. 1 or FIG. 2a.

It will also be noted that, in the first-mentioned case, equipment item A is the participant equipment item and equipment item B is the reciprocal participant equipment item, in a non-limiting manner.

In the embodiment of FIG. 2b, it is mentioned that the procedure of authentication between the participant equipment item A and the reciprocal participant equipment item B comprises, by way of non-limiting example, three authentication levels: a strong authentication level, an intermediate authentication level and a zero authentication level.

It is mentioned, by way of non-limiting example, that the strong authentication level corresponds to an authentication procedure implementing, for example, algorithms that are particularly suitable for verifying a signature and deciphering, that the intermediate authentication level corresponds, for example, to the absence of verification of the strong authentication level, an intermediate authentication procedure then being introduced, and that the zero authentication level corresponds to the absence of verification of the strong authentication level and the intermediate authentication level, only the identifier IdB of the reciprocal participant equipment item B being said to belong to the list of equipment identifiers contained in the participant equipment item A, for example.

Referring to FIG. 2b, it is mentioned, by way of non-limiting example, that step 0, corresponding to the step of transmission from the reciprocal participant equipment item B to the participant equipment item A of the identifier IdB and of the authentication values Auth(IdB), corresponds to a first sub-step 01, involving the transmission of these elements to the participant equipment item A.

The sub-step 0₁ is then followed by step 1, step 2 and optionally step 3, as in the above-described FIG. 1 or FIG. 2a.

By way of non-limiting example, it is mentioned that the step involving the recovery of the identifier IdB of the reciprocal participant equipment item B, then the verification of the authentication values, may then be carried out according to a high-authentication-level authentication procedure, the calculation and the signature verification, for example by means of suitable algorithms, being carried out during the aforementioned step 1.

The aforementioned step 1 is then followed by step 2 of the aforementioned test and step 3, as in FIG. 1 or FIG. 2a.

In the event of a positive response to the test 2 of the affiliation of the identifier IdB to the list of identifiers L_ID_{A}, the authentication procedure according to the high authentication level may then be initiated.

In other words, step 4 of FIG. 1 or FIG. 2a is called by taking into account the plurality of authentication levels that are capable of being verified.

Under these conditions, the aforementioned step 4 may comprise a test step 4₁, consisting in verifying to its true value the result of the verification of the authentication value, obtained following the aforementioned calculation of δ (Auth(IdB)).

In the event of a positive response to the aforementioned verification test 4₁, the test 4₁ is then followed by a step 4₂, allowing the behavior associated with the identifier IdB to be recovered in the verification of a strong authentication level.

The aforementioned step 4₂ is then followed by step 5, consisting in the application of the behavior associated with the identifier IdB by means of the participant equipment item A, as in FIG. 1 or 2a.

Conversely, in the event of a negative response to test 4₁, the strong authentication level not having been verified, the procedure relating to the intermediate authentication level may be called.

As shown in FIG. 2b, this procedure may consist in requesting the displaying of a carrier code of the reciprocal participant equipment item B, wherein this carrier code may correspond to the PIN code of the user of the reciprocal participant equipment item B, for example, at step 0₂ shown in FIG. 2b.

The aforementioned carrier code is known as the PIN(IdB). It may, in any case, consist of an item of information present in the card or, if appropriate, of a code entered into the keyboard by the user, for example.

The test step 4₁ is then followed by a step 6₁, involving the recovery and verification of the aforementioned carrier code PIN(IdB).

The verification step may consist in a test step involving the verification of the value of the aforementioned carrier code, verifying the equation:
PIN(IdB)correct ?

The sub-steps 6₁ and 6₂ form, in fact, a step 6, corresponding to an intermediate-authentication-level authentication step.

In the event of a positive response to the verification test of the carrier code 6₂, the behavior associated with the identifier IdB for the aforementioned verified carrier code is then recovered. The recovered corresponding behavior is then applied in step 5.

Conversely, in the event of a negative response to the aforementioned test step 6₂, a step corresponding to a zero authentication level is called. It will be recalled that the zero authentication level may, by way of non-limiting example, simply consist in the subsequent verification of the affiliation of the identifier IdB to the aforementioned list of identifiers L_ID_{A}.

Under these conditions, the behavior associated with the wrong PIN carrier code value and with the identifier IdB of the reciprocal participant equipment item is subsequently recovered, and, by returning to step 5, this behavior associated with the aforementioned identifier is then applied.

Various embodiments of lists of equipment identifiers, lists of behavior identifiers and lists of associations between an equipment identifier and a behavior identifier will now be presented with reference to FIGS. 2c and 2d.

FIG. 2c shows the aforementioned lists attributed, by way of non-limiting example, to the participant equipment item A, the aforementioned lists being said to be identical to those attributed to the participant equipment item A of FIG. 1, in order not to render the notation excessively complex.

Similarly, FIG. 2c shows the corresponding lists relating to the reciprocal participant equipment item B, these lists verifying the equations:
lists of equipment identifiers:
   L_IDB=[IdA,IdD,IdE]
lists of behavior identifiers:
   L_CB=[RCB₁,RCB₂, . . . ,RCBₕ, . . . ,RCBᵣ]
behavior identifier:
   RCBₕ=[CB₁, CB₂, . . . , CB_{q}]
lists of associations between an equipment identifier and a behavior identifier:
   L_IC_{B}=[[IdA[RCB₂]];[IdD[RCB₁]]].

As far as the structure of the behavior identifiers RCAₖ and RCBₕ, respectively, is concerned, it is mentioned that said identifiers may be formed by a list comprising at least one element forming a behavior reference or interactive dialogue acceptance, interactive dialogue refusal or interactive dialogue conditional acceptance elementary behavior.

By way of non-limiting example, it is mentioned that in order to fulfill a function of this type, each list defining a behavior identifier RCAₖ and RCBₕ, respectively, may comprise an elementary behavior value or a specific behavior reference value, placed, for example, at the head of the list, i.e. the head element of list CA₁ and CB₁, respectively, corresponding, for example, to an interactive dialogue acceptance, interactive dialogue refusal or interactive dialogue conditional acceptance coded value. The coded values may be of any kind, the acceptance of the interactive dialogue, the refusal of the interactive dialogue or else the conditional acceptance of this interactive dialogue being associated, on a mere reading, with each corresponding coded value.

By way of non-limiting example, in the event of the coded value corresponding to an interactive dialogue conditional acceptance coded value, the reading of this coded value at the head of the list allows a function of the elementary behaviors or successive behavior references CA₂, . . . , CAₚ and CB₂, . . . , CB_{q}, respectively, to be called, for example.

Generally, it is mentioned that the aforementioned coded values of elementary behaviors, forming identifiers of behaviors RCAₖ and RCBₕ, respectively, may correspond to coded values for calling function primitives implemented by the participant equipment item A relative to the reciprocal participant equipment item B and function primitives of the reciprocal participant equipment item B implemented relative to the participant equipment item A, respectively.

It will be recalled that the aforementioned functions designate the functions of each equipment item and, if appropriate, the use of such functions by the user of each equipment item, as will be described below in the description.

FIG. 2d shows embodiments of the aforementioned lists in a more particular case, wherein the participant equipment item A is formed by a terminal and the reciprocal participant equipment item B is formed by a microprocessor card or a software module serving as a card of this type relative to the aforementioned terminal, the terminal being provided with a card reader and data being exchanged between the terminal and the card in accordance with the ISO 7816 protocol.

The embodiments of the list of equipment identifiers, the list of behavior identifiers and the list of associations between an equipment identifier and a behavior identifier will be described in the more particular, non-limiting case wherein the participant equipment item is formed by a decoder terminal and is a terminal for descrambling scrambled information and wherein the card forming the reciprocal participant equipment item is a dedicated card attributed to any authorized user of this descrambling terminal.

In an application of this type, it will be recalled that the scrambled information is transmitted in point-multipoint mode from an emission center, for example, and that the set formed by the participant equipment item A, the descrambling terminal, the reciprocal participant equipment item B and the microprocessor card allows access to this scrambled information to be controlled.

It will be recalled, in particular, that access to this information is controlled from access control messages, known as ECM messages, containing the cryptogram of a control word and access criteria transmitted periodically with the scrambled information.

Under these conditions, the dedicated microprocessor card serves as an access control module. The access control module comprises at least one security processor and a secure, programmable, non-volatile memory comprising access rights written into the aforementioned programmable, non-volatile memory.

The written access rights are managed from messages for managing access rights, these messages being transmitted with the scrambled information.

Finally, it will be recalled that access to this information is controlled by verifying the identity of at least one access control right written into the card and one of the access criteria transmitted by the access control messages, this identity verification being followed by deciphering by means of the reciprocal participant equipment item, i.e. by means of the microprocessor card, of the cryptogram of the control word from an operating key, in order to restore the original control word. The original control word is transmitted, after having being deciphered by the microprocessor card, i.e. by the reciprocal participant equipment item B, to the descrambling terminal, the participant equipment item A, in order to allow the scrambled information to be descrambled by said terminal from the restored control word.

FIG. 2d shows, by way of non-limiting example, the lists L_ID_{A} and L_CA: the lists of equipment identifiers and the lists of behavior identifiers of the participant equipment item A, i.e. of the descrambling terminal. These lists are said to be identical to those described with reference to FIG. 1, in order not to render the notation excessively complex.

The same is true as far as the reciprocal participant equipment item B is concerned, i.e. the card, for which the lists L_ID_{B} and L_C_{B} are identical to those of the reciprocal participant equipment item B shown in FIG. 2c.

Nevertheless, as far as the behaviors identified by the respective behavior identifiers RCAₖ and RCBₕ of the participant equipment item A and the reciprocal participant equipment item B are concerned, it is mentioned that in this situation these identifiers and, as a result of the specific embodiment of the intercommunication between the participant equipment item A and the reciprocal participant equipment item B formed by the card, these behaviors have a specific structure, which is that of a bit string at a value of zero or one.

The values indicated in FIG. 2d are entirely arbitrary and correspond to a number of determined successive bits, which have been concatenated to form the aforementioned behaviors.

It will be understood, in particular, that in the embodiment relating to FIG. 2d, i.e. in the situation wherein the participant equipment item A is a terminal, such as a descrambling terminal, and the reciprocal participant equipment item B is a microprocessor card, each successive bit forming the value of the behavior is in fact an elementary behavior or behavior reference, the position of which corresponds to the elements of lists CAₚ and CB_{q}, respectively, of FIG. 2c, for the same values of behaviors identified by RCAₖ and RCBₕ, respectively.

It will be understood, in particular, that in the embodiment of FIG. 2d, the position of each bit in the bit string forming the behaviors in fact defines an elementary behavior or behavior reference, and the value of the corresponding bit, one or zero, designates the implementation of a function or the absence of the implementation of a corresponding function, defining this elementary behavior or behavior reference.

Various examples of behaviors of a descrambling terminal and of a microprocessor card, or subscription card, associated therewith, respectively, will now be given with reference to the aforementioned FIG. 2d.

Generally, and in the access control application, in particular, a dedicated microprocessor card that is attributed to a subscriber is capable of processing various actions that may be requested of it by means of the management messages transmitted during the access control procedure. By way of example, and in a non-limiting manner, it is mentioned that these actions comprise:
authentication of the descrambling terminal,
writing/modification of a service key, for example,
writing/modification of a certificate,
writing/modification/deletion of a right written into the programmable, non-volatile memory of the card,
consultation of an internal data item, such as a secure data item, for example, value of an access or other title.

The above list is not exhaustive.

In accordance with the protocol according to the present invention, and referring to FIG. 2d, it is mentioned that the list of actions or functions implemented by the card is thus shown by the bit string illustrating the behavior identified by RCBₕ, as shown in FIG. 2d.

If the bit of an action or a function has a value of zero, the card refuses to execute this action; however, if it has a value of one, the card may execute this action or this function.

Similarly, the terminal is also capable of carrying out various operations that are requested of it in the management messages, for example, or in its interactive dialogue with the microprocessor card, the descrambling terminal serving as the participant equipment item A and the microprocessor serving as the reciprocal participant equipment item B, for example.

The descrambling terminal is thus able to carry out the following operations:
authentication of the card
writing/modification of a service key in the terminal,
writing/modification of a certificate,
transmission of the management messages to the card,
transmission of the control messages to the card.

The above list is not exhaustive.

As in the case of the reciprocal participant equipment item, various examples of behaviors of a descrambling terminal and of a microprocessor card serving as an access control module, each of these elements serving as the participant equipment item A and the reciprocal participant equipment item B, respectively, will now be given with reference to the elements of FIG. 2d, in particular structures of lists described above in the description.

The aforementioned examples relate, in particular, to the steps of the recovery of the identifiers, the verification of the authentication values, the testing to the true value of these authentication values, the application of a behavior associated with the authentication verified at the false value, and the application of the default behavior, as described above with reference to FIGS. 1, 2a and 2d.

Generally, it is mentioned that the notion of the participant equipment item and the reciprocal participant equipment item, respectively, is interchangeable between the descrambling terminal and the card associated therewith. This notion of interchangeability is justified by the fact that the procedures for adapting the interactivity may be rendered entirely independent of one another.

Thus, if the procedure of authentication of the descrambling terminal by means of the card has not been achieved, i.e. in the event of a negative response to test 2 of FIG. 2a for the reciprocal participant equipment item B, for example, the card has not been able to authenticate the descrambling terminal or, if the card has achieved authentication, said card knows the identifier IdA of the descrambling terminal.

The same is true if, following the procedure of authentication of the card by means of the descrambling terminal, the participant equipment item A, said terminal has not authenticated the card, the reciprocal participant equipment item B; or if it has authenticated it, said terminal knows the identifier IdB of the card, i.e. of the reciprocal participant equipment item B. It will be recalled that, in the particular case of access control, the identifier IdB of the card may be formed by the unique address UA thereof. Each element, the participant equipment item A and the reciprocal participant equipment item B, i.e. the terminal and the card, is thus capable of selecting the behavior to be applied relative to the other element: the card or the terminal, respectively.

The following may thus be examples of behavior:

### EXAMPLES OF BEHAVIOR OF THE CARD THE RECIPROCAL PARTICIPANT EQUIPMENT ITEM

Behavior in the event of a failure to authenticate the terminal by means of the card:
   Invalidation of all of the actions of the card, except for those relating to the authentication of the descrambling terminal.
Behavior if the descrambling terminal has authenticated the card and is not authorized to conduct an interactive dialogue with the card, the terminal being considered to have been “blacklisted”:
Invalidation of all of the actions of the card, except those relating to the authentication of the terminal.

A behavior of this type may be applied by the card, i.e. by the reciprocal participant equipment item B, if said item has authenticated the descrambling terminal, the participant equipment item A, and if the identifier of the terminal IdA is associated with a behavior identifier relative to terminals that are considered to have been “blacklisted”.

It is mentioned, by way of non-limiting example, that the specific behavior value corresponds to a bit string, all of the bits of which have a value of zero, except for the bit corresponding to the authentication of the descrambling terminal, the participant equipment item A.
Behavior controlling the adaptation, i.e. the matching, of the interactivity of the card, the reciprocal participant equipment item B, with one or more descrambling terminals, the participant equipment item A, the terminal or terminals being considered to have been written into the list of authorized terminals:
   All of the actions of the card may be authorized, the selection of the validated actions or functions in the card depending solely on the desired functionalities in this matching.

It will be understood that, in this situation, the bit string that is representative of the behavior, i.e. the bit chain identified by RCBh, has a series of values of one and zero, as a function of the actions or functions of the validated card.

A behavior of this type is applied by the card, the reciprocal participant equipment item B, if said item has authenticated the terminal, the participant equipment item A, and if the identifier of the terminal IdA is in the list, known by the card, of terminals that are considered to have been written into the list of authorized terminals, as a result of the behaviors associated therewith.
Default behavior:
   This behavior is applied by the card, the reciprocal participant equipment item B, if said item has authenticated the terminal and if the identifier of this terminal, the participant equipment item A, the corresponding identifier IdA of which is not in the list of identifiers L_ID_{B} of the card, [ . . .].

Consequently, no specific behavior may be selected. In this situation, the default behavior is applied. By way of example, for this default behavior, all of the actions of the reciprocal participant card B may be authorized.
Association of the default behavior with effective matching, i.e. with the list of association of lists L_IC_{B}:
Invalidation of all of the actions of the card, except those relating to the authentication of the descrambling terminal, the participant equipment item A.

### EXAMPLES OF BEHAVIOR OF THE DESCRAMBLING TERMINAL, THE PARTICIPANT EQUIPMENT ITEM A

Behavior in the event of the terminal failing to authenticate the card:

This situation corresponds to the negative response to the step of test 2 of FIG. 2a for the participant equipment item A.
Invalidation of the operations comprising exchanges with the card, except those relating to the authentication of the card.
Behavior if the card, the reciprocal participant equipment item B, has authenticated the descrambling terminal and is not authorized to conduct an interactive dialogue with the terminal, the participant equipment item A, the card being considered to have been “blacklisted”:
Invalidation of the operations comprising exchanges with the card, except those relating to the authentication of the card.

The aforementioned behavior is then applied by the terminal if said terminal has authenticated the card and if the identifier of the card, i.e. the unique address UA thereof, is associated with a behavior identifier relative to cards that are considered to have been “blacklisted”.

It will be understood that, in the example given above in the description, as in the case of the card, the descrambling terminal, the participant equipment item A, may obviously have card identifiers that are considered to have been “blacklisted”, which, although they are authorized to initiate the interactive dialogue, have lost the facility to initiate this interactive dialogue as a result, in particular, of the failure to adhere to constraints established for the execution of this interactive dialogue.

It will be understood, in particular, that this facility may be withdrawn if the card comprises an application for managing an electronic token facility or electronic wallet, when a debit balance, in terms of the number of tokens per user of the card, for example, has been reached excessively frequently.

Thus, according to a particularly notable aspect of the protocol for adapting the interactivity of the participant equipment item and the reciprocal participant equipment item according to the present invention, it is possible not only to adapt the nature or the degree of interactivity and the interactivity of equipment items communicating in an interactive dialogue as a function of functionalities or actions of each of these equipment items relative to another equipment item, but also, if appropriate, of a use of these functions or actions by the user of said items.
Behavior controlling the adaptation or matching of the interactivity of a descrambling terminal, the participant equipment item A, relative to one or more cards, the reciprocal participant equipment item B, the card or cards being considered to have been written into the list of authorized cards:
   All of the processing of the terminal may then be authorized, in particular those relating to the exchange of messages with the card according to the ISO 7816 protocol, the selection of the other validated operations depending on the desired functionalities in this adaptation.

The aforementioned behavior is then applied by the terminal, the participant equipment item A, if said terminal has authenticated the card at the step of test 2 and if the identifier of the card IdB=UA is contained in the list, known by the terminal, of cards that are considered to have been written into the list of authorized cards, as a result of the behaviors associated therewith.

Under these conditions, and in the event of a positive response to the step of test 2 relating to the participant equipment item A of FIG. 2a, the behavior is read in the form of a bit string having a value of zero or one, in succession, bit string identified by RCAₖ, which is representative of the chosen behavior.
Behavior relative to a non-rechargeable, pre-charged card:
   In this situation, it will be understood that the card, serving as the reciprocal participant equipment item B, comprises pre-written rights, these pre-written rights not being renewable.

Under these conditions, the behavior of the descrambling terminal, the participant equipment item A, may correspond to an invalidation of the processing relating to the exchange with the card of messages relating to the management of the access titles written on the card, i.e. to the invalidation of EMM-type messages, such as management messages, for example. The selection of the other validated processing for the descrambling terminal, the participant equipment item A, depends on the desired functionalities relative to this type of card. In particular, and in order to ensure the use of the card by the user who has acquired this card during the period authorized by the pre-written rights, the transmission of access control messages, known as ECM messages, to the card is obviously valid.

This behavior is applied by the terminal, the participant equipment item A, if said terminal has authenticated the card, the reciprocal participant equipment item B, and if the type of card corresponds to a non-rechargeable, pre-charged card.
Default behavior:
   This default behavior corresponds to step 3 of FIG. 2a, relating to the participant equipment item A.

A behavior of this type is applied by the terminal relative to the card if said terminal has authenticated the card and if, in response to the affiliation test of step 2, the identifier of the card IdB does not belong to the list L_ID_{A} of the terminal. Under these conditions, no specific behavior may be selected for the terminal, the participant equipment item A, relative to the card, the reciprocal participant equipment item B. Under these conditions, the default behavior may be, by way of non-limiting example:
All of the processing of the terminal is authorized, in particular those relating to the exchange of messages with the card.

Finally, and in the implementation of the protocol according to the present invention, it is mentioned that, in a specific preferred, non-limiting embodiment, the steps consisting in writing, into each participant equipment item or each reciprocal participant equipment item, the list of equipment identifiers, the list of behavior identifiers and the list of associations between an equipment identifier and a behavior identifier are preferably implemented by means of the transmission of messages for managing access rights, known as EMM messages, as mentioned above in the description. It will be understood, in particular, that the aforementioned writing procedures may relate either to the first writing of the aforementioned lists into existing equipment items or, conversely, the updating of existing lists, as described above.

Specific examples of behaviors that are suitable, more particularly, for managing a descrambling terminal, serving as a participant equipment item A, for example, and a dedicated card, allocated to an authorized user and serving as the reciprocal participant equipment item B, if the procedure of authentication between the descrambling terminal and the card is a procedure at more than one authentication level, will now be given.

In the aforementioned case, the procedure, or operating mode, of the protocol according to the present invention is strictly in accordance with the protocol described with reference to FIG. 2b, the authentication procedure comprising a strong authentication level, an intermediate authentication level and a zero authentication level, as described above with reference to the aforementioned figure.

Under these conditions, the protocol according to the invention may, for example, consist, in accordance with the authentication level achieved and as a function of the identity of the reciprocal participant equipment item:
For an achieved strong authentication level, i.e. in the event of a positive response to sub-step 41 of FIG. 2b, in authorizing an access mode by impulse buying to sub-step 42, described above with reference to FIG. 2b. It will be recalled that the access mode by impulse buying is the subject of a definition in standard UTE C 90 007.
Conversely, for an achieved intermediate authentication level, i.e. an authentication level corresponding to a strong authentication level that has not been achieved, i.e. in the event of a negative response to the aforementioned sub-step of test 4₁, but following an achieved displaying of a carrier code of the card, the reciprocal participant equipment item, following the implementation of steps 0₂, 6₁ and 6₂ of FIG. 2b, the protocol according to the invention may then consist in authorizing the processing of all of the management messages, known as EMM messages, and of all of the access control messages, known as ECM messages, mentioned above in the description, apart from the access mode by impulse buying.

It will be understood, in particular, that in order to authorize impulse buying, this authorization is rendered consequential on the verification of a strong authentication level in order, for example, to ensure the security of transactions relating to impulse buying.
Conversely, for an achieved individual zero authentication level, i.e. in the event of a negative response not only to the aforementioned sub-step 4₁, but also to sub-step 6₂, mentioned above in the description, the zero authentication level then corresponds to a strong authentication level that has not been achieved and to a displaying of the carrier code of the reciprocal participant equipment item, i.e. the card, that has not been achieved. The protocol according to the invention then consists in authorizing the processing of individual management messages, known as EMM messages, mentioned above in the description. In this last case, it will be understood that the authorization to process the individual EMM management messages allows the actions carried out by the user of the card, i.e. the reciprocal participant equipment item B, to be controlled, said user then only being able to carry out operations for updating the rights written into the card, i.e. into the reciprocal participant equipment item, and of cryptographic or other values, in order to allow complete updating of the set of data written into the reciprocal participant equipment item and then to allow said set to implement the protocol according to the present invention according to all of the possibilities shown in FIG. 2b.

Embodiments of the protocol according to the present invention, allowing adaptation of the interactivity between a plurality of computer equipment items of a given set of computer equipment items, will now be presented with reference to FIGS. 3a, 3b and the following figures.

FIG. 3a relates to the application of the protocol according to the present invention to a set of N equipment items connected in a network, for example, and each capable of executing an interactive dialogue with another equipment item of this set of equipment items.

In FIG. 3a, the number of equipment items has deliberately been limited to five, in order not to render the drawing excessively complex.

In a situation of this type, the protocol according to the present invention consists in attributing to an equipment item, equipment item A, for example, the role of the participant equipment item for all transactions, by transmitting a query message to another equipment item of this set of equipment items.

In FIG. 3a, by way of non-limiting example, equipment item A is the participant equipment item ei₁ for a first transaction relative to the equipment item D, which is then the reciprocal participant item eir₁ for the same transaction 1.

The protocol according to the invention also consists in attributing, to this other equipment item, equipment item D, and, for this transaction, transaction 1, the role of the reciprocal participant equipment item.

It also consists in attributing, to the participant equipment item A, the role of the reciprocal participant, for all other transactions that are separate from this transaction, transaction 1, on receipt by this equipment item, the participant equipment item A, of a query message issuing from another, separate equipment item belonging to the set of the aforementioned equipment items.

It will be understood from FIG. 3a that the participant equipment item A becomes the reciprocal participant equipment item eir₄ relative to transaction 4 initiated by equipment item E, the participant equipment item for the aforementioned transaction 4. Equipment item E is the other equipment item, separate from equipment item A, to which, for transaction 4, the role of participant equipment item ei₄ has been attributed.

The protocol according to the present invention therefore consists in successively applying this protocol between any equipment items, any other equipment items and any other, separate equipment items belonging to the set of equipment items to which the role of the participant equipment item and/or the role of the reciprocal participant equipment item has been attributed in succession.

The protocol according to the present invention therefore allows a suitable interactive dialogue to be executed between any equipment items of this set of equipment items by means of pairs of equipment items, to which the roles of participant and reciprocal participant, respectively, have been attributed. It will be understood, in particular, that the sequence of the transactions and the order number attributed to said transactions are not representative of the time sequence of said transactions. A table relating to FIG. 3a will be introduced below, in which the successive states of the participant equipment item and the reciprocal participant equipment item, respectively, are indicated for equipment items A, B, C, D, E and transactions 1, 2, 3, 4 shown in FIG. 3a.

TABLE
(FIG. 3a)

EQ

| t | A | B | C | D | E |
|---|---|---|---|---|---|
| 1 | ei₁ | | | eir₁ | |
| 2 | | | eir₂ | ei₂ | |
| 3 | | eir₃ | ei₃ | | |
| 4 | eir₄ | | | | ei₄ |

Another embodiment of the protocol according to the present invention, in the case of the use of a terminal and a plurality of cards intended to conduct an interactive dialogue with this terminal, will now be presented with reference to FIG. 3b.

In this situation, a descrambling terminal of this type, for example, or a bank card-reading terminal, for example, which is intended to execute an interactive dialogue with a plurality of these cards, in succession, will be considered.

FIG. 3b shows, by way of non-limiting example, a terminal, in the form of a computer equipment item A forming a participant equipment item, for example, and a plurality of cards B, C, D, E intended to enter into communication in succession with the terminal A. It will be understood, in particular, that the cards may be introduced in succession into the card reader of the terminal A or, conversely, that each card may be coupled to a card reader and to an auxiliary system, not shown in the drawing, the auxiliary system provided with the card being able to enter into communication in succession with the terminal A, for example.

According to one aspect of the protocol according to the present invention, the role of participant equipment item for each successive transaction, for example, is attributed to the terminal A.

Under these conditions, the equipment item A is the participant equipment item ei₁, ei₂, ei₃, ei₄ for each of the successive transactions.

Conversely, each equipment item B, C, D, E is then, consequently, the reciprocal participant equipment item for the corresponding transaction, transactions 3, 4, 1, 2, as shown in FIG. 3b. The table relating to FIG. 3b summarizes the successive state of each of the equipment items shown in the aforementioned figure.

TABLE
(FIG. 3b)

| | EQ | | | | |
|---|---|---|---|---|---|
| t | A | B | C | D | E |
| 1 | ei₁ | | | eir₁ | |
| 2 | ei₂ | | | | eir₂ |
| 3 | ei₃ | eir₃ | | | |
| 4 | ei₄ | | eir₄ | | |

A more detailed description of different variations of the protocol according to the present invention for a given set N of equipment items connected in a network, for example, and each capable of executing an interactive dialogue with another equipment item of this set of equipment items, will now be given in succession with reference to FIG. 4a to 4f and 5a.

Referring to FIG. 4a, it is mentioned that the number N of equipment items is not limited, but that, in order not to render the drawings excessively complex, the number of equipment items shown in FIG. 4a and 5, for example, has been reduced to three in a non-limiting manner.

Referring to FIG. 4a, it is mentioned that the protocol according to the present invention consists in attributing to one of the equipment items, equipment item A, for example, the role of participant equipment item for all of the transactions, by transmitting a query message to a plurality of other equipment items, forming a subset of the aforementioned set of equipment items. In FIG. 4a, the subset of equipment items is formed by equipment item B and equipment item C.

By way of non-limiting example, it will be recalled that equipment item A, serving as the participant equipment item, has the list of equipment identifiers L_ID_{A}, the list of behavior identifiers L_CA comprising the various behavior identifiers RCAₖ and the list of associations L_IC_{A} between an equipment identifier and a behavior identifier. The aforementioned lists correspond, for example, to the lists that have already been defined in relation to FIG. 1 or FIG. 2a.

The same is true of equipment item B, which has the list of equipment identifiers L_ID_{B}, the list of behavior identifiers L_C_{B}, the behavior identifiers RCBh and the list of associations L_IC_{B}. These lists also correspond to the lists possessed by equipment item B in FIG. 2a, for example.

Similarly, and by way of non-limiting example, equipment item C has:
a list of behavior identifiers verifying the equation:
   L_ID_{C}=[IdA,IdB, . . . ,IdF],
a list of behavior identifiers verifying the equation:
   L_C_{C}=[RCC₁, RCC₂, . . . , RCC₁, . . . , RCC_{S}], the behavior identifiers RCC₁ verifying the equation:
   RCC₁=[CC₁, CC₂, . . . , CCₒ], the elements CC₁ to CCₒ defining behavior references
   or elementary behavior, for example;

a list of associations between an equipment identifier and a behavior identifier verifying the equation:
L_ICC=[[IdA[RCC]];[IdB[RCC]]; . . . ].

All of the aforementioned lists are shown in FIG. 4b.

Referring to FIG. 4a, it is mentioned that the protocol according to the present invention consists in attributing, to each of the other equipment items to which the query message is addressed, i.e. to equipment items B and C, for the aforementioned transaction, the role of the reciprocal participant equipment item relative to the participant equipment item A.

It then consists in applying the protocol between the equipment item to which the role of participant equipment item has been attributed, i.e. equipment item A, and each of the other equipment items, equipment item B and equipment item C of the subset of equipment items.

Under these conditions, in accordance with the protocol according to the invention, said protocol comprises, at the participant equipment item A, a procedure of authentication between the participant equipment item and each of the other equipment items of the plurality of equipment items to which the role of reciprocal participant equipment item has been attributed, i.e. to equipment items B and C. This authentication procedure is implemented from step 1, which is shown in FIG. 4a relative to equipment item B and equipment item C, respectively, these steps being in accordance with the embodiment as shown in FIG. 1 or 2a, for example.

Following the authentication procedure, a procedure for distinguishing the behavior of the participant equipment item A relative to each of the other equipment items of the number of other equipment items, equipment items B and C, to which the role of reciprocal participant equipment item has been attributed, is called.

The distinguishing procedure comprises a test step 2 comparable to that implemented in FIG. 2a, allowing the affiliation of the identifiers IdB and IdC, respectively, to the list of identifiers L_ID_{A} of the participant equipment item A to be verified. In the event of a negative response to the aforementioned test 2 for each of the other equipment items B and C, the default behavior 3 is called. Conversely, in the event of a positive response to the test 2 of the affiliation of the identifiers to the aforementioned list of equipment identifiers, step 4, involving the recovery of the behavior of the participant equipment item A associated with the identifier IdB, IdC is called in a similar manner to the operating mode of FIG. 2a, for example. As in the aforementioned figure, the behavior is associated with each equipment identifier and with the result of the authentication procedure.

The aforementioned steps 4, involving the recovery of the behavior, may then be followed by a procedure 5 for determining the common behavior of the participant equipment item A relative to each of the other equipment items B and C, to which the role of reciprocal participant equipment item has been attributed.

This operation for calculating the common behavior CC_{ABC} corresponds to a logical operation performed on the behaviors associated with each of the reciprocal participant equipment items B and C. It is shown in step 5 of FIG. 4a and is denoted by CC_{ABC}=RCAₓ\hat{×}RCA_{y}.

It will be understood that, for a behavior of the participant equipment item A relative to each of the other reciprocal participant equipment items B and C, respectively, formed by a behavior identifier designating a list of elementary behaviors of this participant equipment item, the procedure for determining the common behavior consists in calculating, by means of the aforementioned logical operation performed on the aforementioned lists, the list of elementary behaviors resulting from the logical operation performed on the lists defining these behaviors.

Thus, in the preceding equation, CC_{ABC} designates the common behavior of A relative to B and C, and RCAₓ and RCA_{y} designate the behavior identifiers of the participant terminal A relative to the reciprocal participant equipment item B and the reciprocal participant equipment item C, respectively.

In a first embodiment as shown in FIG. 4c, step 5 may consist, for the calculation of the aforementioned common behavior, in determining, from the list of associations L_IC_{A} and, in particular, relative to the elements of the lists, the head of which corresponds to the identifiers IdB and IdC, respectively, the corresponding behaviors RCA₁, RCAₚ, the common behavior being determined by calculating the intersection of the lists that are representative of the behaviors identified by RCA₁ and RCAₚ, for example, according to the equation:
CC_{ABC}=RCA₁∩RCAₚ.

It is in fact possible to calculate the intersection of the lists of all of the behaviors allocated to each of the reciprocal participant equipment items, and therefore to the identifiers IdB and IdC, and to retain the most favorable resulting list.

Although the operating mode of FIG. 4c is intended, more particularly, for terminals, i.e. for equipment items connected in a network, the protocol according to the present invention may also be implemented, as shown in FIG. 4d, from a descrambling terminal forming the participant equipment item A, for example, and if a plurality of dedicated cards that have been allocated to subscribers are associated with a descrambling terminal of this type.

In this situation, only the nature of the list of associations L_IC_{A} is modified, in so far as the behavior identifiers are formed not by lists, but by bit strings having a specific value, strings b and c, for example, as shown in the aforementioned FIG. 4d.

Thus, each bit string is considered in turn as a list element or an equivalent data structure.

The logical operation performed on the behaviors identified by the behavior identifiers, such as behaviors b and c, for example, may then be implemented in a similar manner to that shown in FIG. 4c.

Under these conditions, the common behavior CC_{ABC} verifies the equation:
CC_{ABC}=b∩c=bitand(b, c)

In the preceding equation, it is mentioned that the bitand function designates the intersection operation, i.e. the bit-to-bit logical operation AND between elements b and c, for example.

The logical operation performed on behaviors shown by lists is obviously not limited to the operation of list intersection.

By way of non-limiting example, it is mentioned that the procedure for determining the common behavior may consist in calculating the list resulting from the union of the behavior lists.

As shown in FIG. 4e, for terminals connected in a network, for example, step 5, shown in FIG. 4a, may consist in calling the list L_IC_{A}, the list of associations between an equipment identifier and an identifier of the behaviors of the participant equipment item A, and in calculating the union of the lists of elementary behaviors identified by RCA₁ and RCAₚ, for example, in order to define the common behavior CC_{ABC} verifying the equation:
CC_{ABC}=RCA₁URCAₚ.

As far as the implementation of the protocol according to the invention in a terminal, such as a descrambling terminal and a plurality of cards associated therewith, is concerned, the operation performed on the behaviors designated by b and c in FIG. 4f, these behaviors being defined by bit strings, may correspond to a union operation, the common behavior then being defined by the equation:
CC_{ABC}=bUc=bitor(b,c).

It is mentioned that the bitor equation shows the bit-to-bit operation OR between elements b and c. The result of the operation, in the example given in FIG. 4f, is equal to 010011.

Another embodiment of the protocol according to the present invention, for a given set of N equipment items connected in a network, for example, each equipment item being capable of executing an interactive dialogue with another equipment item of this set, will now be described with reference to FIG. 5.

As in FIG. 4a, it is mentioned that the number of equipment items N forming the set of equipment items is not limited, but that, in order not to render the drawing excessively complex, the number of other equipment items that are separate from equipment item A, considered as the participant equipment item, has been kept to two equipment items B and C.

As in FIG. 4a, it is mentioned that each equipment item, the participant equipment item A and the reciprocal participant equipment items B and C, has a list of equipment identifiers L_ID_{A}, L_ID_{B} and L-ID_{C}, a list of behavior identifiers L_C_{A}, L_C_{B} and L_C_{C} and a list of associations between an equipment identifier and a behavior identifier L_IC_{A}, L_IC_{B}, and L_IC_{C}, as defined above in relation to the aforementioned FIG. 4a. By way of example, the aforementioned lists may correspond to those shown in FIG. 4b.

In particular, it is mentioned that the elementary behavior identified by the behavior identifier, with which an equipment identifier is associated, may itself be formed by a list of elementary behaviors or behavior references, which may be behaviors that are independent of the functionalities of each computer equipment item A, B or C.

Referring to FIG. 5, it is mentioned that the protocol according to the invention then consists in attributing to an equipment item, equipment item A, for example, the role of the participant equipment items for all of the transactions, by transmitting a query message to a number of other equipment items, equipment items B and C being limited to two, as in FIG. 4a.

The protocol according to the invention also consists in attributing, to the set formed by the other equipment items to which this query message is addressed, the aforementioned equipment items B and C for the transaction in question, the role of the reciprocal participant equipment item relative to the participant equipment item A.

It then consists in applying the protocol according to the invention between equipment item A, to which the role of the participant equipment item has been attributed, and the set formed by the other equipment items forming the subset of equipment items to which the role of the reciprocal participant equipment item has been attributed, the protocol comprising, at the participant equipment item, a procedure 1 for authenticating each of the other equipment items, to which the role of the reciprocal participant equipment items B and C has been attributed.

It is mentioned from FIG. 5 that the authentication procedure corresponds to step 1 of FIG. 4a, for example, during which the identifiers IdB and IdC, respectively, are recovered, after which the authentication values are verified according to the operations δ(Auth(IdB)) and δ(Auth(IdC)). The authentication procedure may correspond to that described with reference to the preceding FIGS. 1, 2a or 4a.

As a function of the result of the aforementioned authentication procedure 1, performed for each of the reciprocal participant equipment items and verified authentication levels, each reciprocal participant equipment item is considered as being capable, individually, of executing an interactive dialogue with the participant equipment item A.

According to a notable aspect of the specific embodiment of the protocol according to the present invention, as shown in FIG. 5, said protocol then consists in calling a joint procedure 1₁ for authenticating the subset of the reciprocal participant equipment items relative to the participant equipment item A.

As a function of the result of this joint authentication procedure, the subset of the reciprocal participant equipment items B and C is authenticated as a joint reciprocal participant equipment item for executing the transaction relative to the participant equipment item A.

In FIG. 5, the joint authentication procedure operation is shown in the form of step 11, allowing calculation of the joint authentication logical value verifying the equation:
δ_{CC}=δ(Auth(IdB))ANDδ(Auth(IdC))

The joint authentication procedure 1₁ may then be followed by a joint procedure 2 authorizing the subset of the reciprocal participant equipment items to execute the interactive dialogue relative to the participant equipment item A.

As shown in FIG. 5, the joint authorization procedure may consist in verifying the affiliation of the identifier of the set formed by equipment items A and B, the reciprocal participant, this set being kept to two items in the non-limiting capacity of FIG. 5, to the list of equipment identifiers L_ID_{A} of the participant equipment item A.

In the event of a negative response to the joint authorization test 2, the procedure for applying the default behavior 3 may be called, wherein this procedure may, for example, correspond to the default behavior procedure 3, described above in the description with reference to FIG. 4a. The default behavior is, in this case, defined as a function of the result of the joint authentication procedure δ_{CC}.

Conversely, in the event of a positive response to the joint authorization test, a procedure 4 for distinguishing or recovering the joint behavior of the participant equipment item A relative to the subset of the reciprocal participant equipment items B, C, to which subset the role of joint reciprocal participant has been attributed, is called, this distinguishing procedure corresponding substantially to a procedure for recovering the joint behavior, as will be described below in the description.

The step 4 for distinguishing the joint behavior is then followed by a procedure 5 for applying the joint behavior of the participant equipment item relative to the other equipment items forming the subset to which the role of the joint reciprocal participant has been attributed. The protocol according to the present invention allows a joint behavior of any equipment items of a set of equipment items to be applied relative to all of the plurality of equipment items forming a subset of this set of equipment items, to which subset the role of the joint reciprocal participant has been attributed.

A specific embodiment will be described with reference to FIGS. 5 and 4b.

FIG. 4b shows list structures allowing the implementation of the protocol according to the present invention, as described above in the description referring to FIG. 5.

Referring to FIG. 5, it is mentioned that the test step 2 consists in determining whether the composed identifier, formed by the identifiers (IdB, IdC), is included in the list of equipment identifiers L_ID_{A} of the participant equipment item A. The composed identifier (IdB, IdC), formed by the identifier of the reciprocal participant equipment items B and C, is an identifier of reciprocal participant equipment items that are authorized to participate in the transaction and is approved as the identifier of joint reciprocal participant equipment items relative to the participant equipment item A.

Referring to FIG. 5, it is mentioned that the procedure for distinguishing the joint behavior of the participant equipment item A relative to the subset of the reciprocal participant equipment items B and C may consist in selecting the association between the composed identifier and the behavior identifier.

It will be understood that, in step 4, starting from the composed identifier (IdB, IdC), behaviors defined in the list of associations L_IC_{A}, for example, i.e. the behavior identifiers RCA₁, RCAₖ are called for the aforementioned corresponding composed identifier of the equipment items (IdB, IdC).

Step 4 is then followed by a step 5, consisting in applying the joint behavior.

Referring to FIG. 5 and FIG. 4b, for the composed identifier (IdB, IdC), the joint behavior may be defined by a logical operation performed on the aforementioned behavior identifiers RCA₁, RCAₖ. This behavior is applied to the subset formed by the reciprocal participant equipment items B and C.

It will obviously be understood that, as a function of the coded values of elementary behaviors or behavior references CA₁, CA₂, . . . CAₚ forming each behavior identifier, the aforementioned logical product corresponds to a joint behavior as a function of the logic applied to the aforementioned product.

By way of non-limiting example, it is mentioned that the aforementioned elementary behaviors or behavior references may correspond to highly advanced functional behaviors.

The elementary behavior CA₁ may thus consist of a coded value forming a common element that is held by all of the users of the participant equipment items and the reciprocal participant equipment items, this common element consisting, for example, of a code or a password allowing each user, using the equipment item in his possession, to take part in the aforementioned transaction. The other successive behaviors CA₂ to CAₚ may, for example, correspond to highly diverse functional parameters, such as the use of a common language among a plurality of languages for the transaction, the use of specific enciphering/deciphering parameters for the transaction or the like.

The implementation of the protocol according to the present invention, in the definition of a joint behavior, allows adaptation to extremely diverse situations, such as teleconferences, secure multistation transactions or the like.

1. A protocol for adapting the degree of interactivity between a participant equipment item and a reciprocal participant equipment item of a set of participant equipment items, when this participant equipment item and this reciprocal participant equipment item are subjected to an interactive dialogue, wherein it consists at least:
a) in writing, into said participant equipment item, a list of reciprocal participant equipment identifiers;
b) in writing, into said participant equipment item, a list of behavior identifiers, said behaviors being relevant in said interactive dialogue;
c) in writing, into said participant equipment item, at least one association between an equipment identifier and a behavior identifier and, in order to execute this interactive dialogue, when this participant equipment item and at least one reciprocal participant equipment item are in each other's presence;
d) in carrying out a procedure of authentication between said participant equipment item and said reciprocal participant equipment item, and
in searching for the identifier of the authenticated reciprocal participant equipment item in said list of identifiers;
in reading said associated behavior identifier;
in applying, at the participant equipment item, a behavior relative to the authenticated reciprocal participant equipment item, this behavior being selected as a function of the result of the authentication procedure and associated with the behavior identifier and with the identifier of the reciprocal participant equipment item.

2. The protocol as claimed in claim 1, wherein, in the event of a negative response to the step of searching for the identifier of the authenticated reciprocal participant equipment item in the list of identifiers, said protocol consists in calling and applying a default behavior procedure that is selected as a function of the result of said authentication procedure.

3. The protocol as claimed in either claim 1 or claim 2, wherein said procedure of authentication between the participant equipment item and the reciprocal participant equipment item is a procedure at more than one authentication level.

4. The protocol as claimed in claim 1, for reciprocally adapting the interactivity between a participant equipment item and a reciprocal participant equipment item of a set of participant equipment items, when this participant equipment item and this reciprocal participant equipment item are subjected to an interactive dialogue, wherein it consists:
a) in writing, into each participant equipment item and into each reciprocal participant equipment item, respectively, a list of identifiers of reciprocal participant equipment items and participant equipment items, respectively;
b) in writing, into each participant equipment item and into each reciprocal participant equipment item, respectively, a list of behavior identifiers, said behaviors being defined in said interactive dialogue;
c) in writing at least one association between an equipment identifier and a behavior identifier into each participant equipment item and each reciprocal participant equipment item, each participant equipment item and each reciprocal participant equipment item, respectively, having at least one association between an identifier of reciprocal participant equipment items and a behavior identifier, respectively between an identifier of participant equipment items and a behavior identifier; and, in order to execute this interactive dialogue, when a participant equipment item and a reciprocal participant equipment item are in each other's presence,
d) in carrying out a procedure of reciprocal authentication between said participant equipment item and said reciprocal participant equipment item; and
e) in searching for the identifier of the authenticated reciprocal participant equipment item and of the authenticated participant equipment item, respectively, in said lists of identifiers;
f) in reading at least said associated behavior identifier in the participant equipment item and in the reciprocal participant equipment item, respectively;
g) in applying, independently, at the authenticated participant equipment item and the authenticated reciprocal participant equipment item, respectively, a behavior relative to the authenticated reciprocal participant equipment item and the authenticated participant equipment item, respectively, this behavior being selected as a function of the result of the authentication procedure and associated with the behavior identifier and with the identifier of the reciprocal participant equipment item and with the behavior identifier, respectively, and with the identifier of the participant equipment item.

5. The protocol as claimed in claim 1, wherein said participant equipment item comprises, stored in a non-volatile memory, at least:
a list of identifiers of reciprocal participant equipment items, one of the list elements of which designates the identifier of said reciprocal participant equipment item;
a list of identifiers of the behaviors of said participant equipment item relative to a reciprocal participant equipment item, said list comprising at least one element forming a behavior reference of interactive dialogue acceptance, of interactive dialogue refusal or of interactive dialogue conditional acceptance;
a list of associations between an equipment identifier and a behavior identifier, said list of associations allowing an element of the list of identifiers of reciprocal participant equipment items and an element of the list of behavior identifiers to be brought into correspondence with each other.

6. The protocol as claimed in claim 4, wherein said reciprocal participant equipment item comprises, stored in a non-volatile memory, at least:
a list of identifiers of participant equipment items, one of the list elements of which designates the identifier of said reciprocal participant equipment item;
a list of identifiers of the behaviors of said reciprocal participant equipment item relative to a participant equipment item, said list comprising at least one element forming a behavior reference of interactive dialogue acceptance, of interactive dialogue refusal or of interactive dialogue conditional acceptance;
a list of associations between an equipment identifier and a behavior identifier, said list of associations allowing an element of the list of identifiers of participant equipment items and an element of the list of behavior identifiers to be brought into correspondence with each other.

7. The protocol as claimed in claim 1, wherein said participant equipment item is formed by a terminal, provided with a microprocessor card reader, said reciprocal participant equipment item being formed by a microprocessor card.

8. The protocol as claimed in claim 7, wherein said participant equipment item is formed by a terminal for descrambling scrambled information, said scrambled information being transmitted in point-to-multipoint mode from an emission center, access to this information being controlled from access control messages containing the cryptogram of a control word and access criteria that are transmitted periodically with the scrambled information, and said reciprocal participant equipment item being formed by a dedicated microprocessor card, serving as an access control module, comprising at least one security processor and a secure, programmable, non-volatile memory comprising written access rights, said written access rights being managed from messages for managing the access rights transmitted with the scrambled information, said access to this information being controlled by verifying the identity of at least one access control right that is written into the card and of one of the access criteria, and by deciphering, in said reciprocal participant equipment item of the cryptogram, the control word from an operating key, in order to restore the control word, allowing the scrambled information to be descrambled in said participant equipment item from this restored control word, in said participant equipment item,
said at least one element forming a behavior reference of interactive dialogue acceptance is formed by a list of behaviors relative to reciprocal participant equipment items that are authorized to initiate said interactive dialogue;
said at least one element forming a behavior reference of interactive dialogue refusal is formed by a list of behaviors relative to reciprocal participant equipment items that are authorized to initiate said interactive dialogue, from which the facility to initiate said interactive dialogue has been withdrawn.

9. The protocol as claimed in claim 8, wherein, in said reciprocal participant equipment item,
said at least one element forming a behavior reference of interactive dialogue acceptance is formed by a list of behaviors relative to participant equipment items that are authorized to initiate said interactive dialogue;
said at least one element forming a behavior reference of interactive dialogue refusal is formed by a list of behaviors relative to participant equipment items that are authorized to initiate said interactive dialogue, from which the facility to initiate said interactive dialogue has been withdrawn.

10. The protocol as claimed in claim 5, wherein said at least one element forming a reference of interactive dialogue conditional acceptance is formed by a list, at least one of the elements of which is representative of a functional behavior of said reciprocal participant equipment item and of said participant equipment item, respectively.

11. The protocol as claimed in claim 5, wherein said at least one element forming a reference of interactive dialogue conditional acceptance is formed by a list, at least one of the elements of which is representative of a personal behavior of the user of said reciprocal participant equipment item and of said participant equipment item, respectively.

12. The protocol as claimed in claim 8, wherein the steps of writing into each participant equipment item and/or each reciprocal participant equipment item are implemented by transmitting messages for managing access rights.

13. The protocol as claimed in claim 8, wherein, for an authentication procedure between a descrambling terminal, serving as a participant equipment item, and a card, serving as a reciprocal participant equipment item, comprising a strong authentication level, an intermediate authentication level and a zero authentication level, said protocol consists, in accordance with the achieved authentication level and as a function of the identity of said reciprocal participant equipment terminal:
for an achieved strong authentication level, in authorizing an access mode by impulse buying;
for an achieved intermediate authentication level, corresponding to a strong authentication level that has not been achieved, but to the displaying of a user code for the reciprocal participant equipment that has been achieved, in authorizing the processing of all of the management messages and of all of the access control messages apart from the access mode by impulse buying; and
for a zero authentication level, corresponding to a strong authentication level that has not been achieved, and to the displaying of a user code for the reciprocal participant equipment that has not been achieved, in authorizing the processing of the individual management messages.

14. The protocol as claimed in claim 1, wherein, for a set of N equipment items connected in a network and each capable of executing an interactive dialogue with another equipment item of this set of equipment items, said protocol consists:
in attributing, to one equipment item, the role of participant equipment item for all of the transactions, by transmitting a query message to another equipment item of said set of equipment items;
in attributing, to this other equipment item, for this transaction, the role of reciprocal participant equipment item;
in attributing, to said equipment item, the role of reciprocal participant for all other transactions, separate from this transaction, on receipt, by means of said equipment item, of a query message issuing from another equipment item that is separate from said set of equipment items;
in attributing, to said other, separate equipment item, the role of participant equipment item for said other transaction;
in applying said protocol between any equipment items, any other equipment items, and any other equipment items that are separate from said set of equipment items, to which the role of participant equipment item and/or the role of reciprocal participant equipment item has been attributed, which allows a suitable interactive dialogue to be executed between any equipment items of this set of equipment items by means of pairs of equipment items, to which the roles of participant and reciprocal participant, respectively, have been attributed.

15. The protocol as claimed in claim 1, wherein, for a set of N equipment items connected in a network and each capable of executing an interactive dialogue with another equipment item of this set of equipment items, said protocol consists:
in attributing, to one equipment item, the role of participant equipment item for all of the transactions, by transmitting a query message to a plurality of other equipment items, forming a subset of said set of equipment items;
in attributing, to each of said other equipment items to which said query message is addressed, for this transaction, the role of reciprocal participant equipment item, relative to said participant equipment item;
in applying said protocol between this equipment item, to which the role of participant equipment item has been attributed, and each of the other equipment items of this subset of said set of equipment items, said protocol comprising, at said participant equipment item:
a procedure of authentication between said participant equipment item and each of said other equipment items of this plurality of other equipment items, to which the role of reciprocal participant has been attributed, and, as a function of the result of each authentication procedure,
a procedure for distinguishing the behavior of said participant equipment item relative to each of said other equipment items of this plurality of other equipment items, to which the role of reciprocal participant equipment item has been attributed, and
a procedure for determining the common behavior of said participant equipment item relative to each of said other equipment items of this plurality of other equipment items, to which the role of reciprocal participant equipment item has been attributed, which allows said common behavior of any equipment items of this set of equipment items to be applied relative to the other equipment items of this plurality of other equipment items, forming a subset of said set of equipment items.

16. The protocol as claimed in claim 15, wherein, for a behavior of said participant equipment item relative to each of said other reciprocal participant equipment items, formed by a list of elementary behaviors of this participant equipment item, said procedure for determining the common behavior consists in calculating the list resulting from the intersection of said lists of elementary behaviors.

17. The protocol as claimed in claim 15, wherein, for a behavior of said participant equipment item relative to each of said other reciprocal participant equipment items, formed by a list of elementary behaviors of this participant equipment item, said procedure for determining the common behavior consists in calculating the list resulting from the union of said lists of elementary behaviors.

18. The protocol as claimed in claim 1, wherein, for a set of N equipment items connected in a network and each capable of executing an interactive dialogue with another equipment item of this set of equipment items, said protocol consists:
in attributing, to one equipment item, the role of participant equipment item for all of the transactions, by transmitting a query message to a plurality of other equipment items, forming a subset of said set of equipment items;
in attributing, to each of said other equipment items to which said query message is addressed, for this transaction, the role of reciprocal participant equipment item, relative to said participant equipment item;
in applying said protocol between this equipment item, to which the role of participant equipment item has been attributed, and each of the other equipment items of this subset of said set of equipment items, to which the role of reciprocal participant equipment item has been attributed, said protocol comprising, at said participant equipment item:
a procedure of authentication of each of said other equipment items, to which the role of reciprocal participant equipment item has been attributed, and, as a function of the result of this authentication procedure, each of said other equipment items, to which the role of reciprocal participant equipment item has been attributed, being capable, individually, of executing an interactive dialogue with said equipment item, to which the role of participant equipment item has been attributed,
a joint procedure of authentication of the subset of the reciprocal participant equipment items relative to said participant equipment item, and, as a function of the result of this joint authentication procedure, the subset of said reciprocal participant equipment items being authenticated as a joint reciprocal participant for the execution of said transaction,
a joint procedure for authorizing the subset of the reciprocal participant equipment items to execute the interactive dialogue relative to said participant equipment item and, once the joint authorization procedure has been achieved,
a procedure for distinguishing the joint behavior of said participant equipment item relative to the subset of the reciprocal participant equipment items, to which the role of joint reciprocal participant has been attributed, and, once the distinguishing procedure has been achieved,
a procedure for determining and applying the joint behavior of said participant equipment item relative to said other equipment items, to which the role of joint reciprocal participant has been attributed, which allows said joint behavior of any equipment items of this set of equipment items to be applied relative to all of the plurality of equipment items, to which the role of joint reciprocal participant has been attributed.

19. The protocol as claimed in claim 18, wherein said joint authentication procedure consists in verifying to its true value the logical product of the logical values that are representative of each reciprocal authentication procedure.

20. The protocol as claimed in claim 18 wherein said joint authorization procedure consists:
in establishing, from said list of identifiers of reciprocal participant equipment items, written into said participant equipment item, a composed identifier formed by the identifier of the reciprocal participant equipment items authorized to participate in said transaction and approved as identifiers of reciprocal participant equipment items, for which the joint authentication procedure has been verified to the true value, relative to the participant equipment item.

21. The protocol as claimed in claim 20, wherein said procedure for distinguishing the joint behavior of said participant equipment item relative to the subset of the reciprocal participant equipment items consists:
in selecting the association between the composed identifier and a behavior identifier in said participant equipment item;
in calling, from the composed identifier, the behaviors defined in the list of associations.

22. Computer equipment item comprising input/output means allowing messages to be transmitted and/or received in an interactive dialogue with another computer equipment item, calculation means connected to said input/output means, a working random access memory and at least one programmable, non-volatile memory, wherein said item comprises, written in the non-volatile memory, at least:
a list of computer equipment item identifiers, accessible via said input/output means;
a list of behavior identifiers defined in said interactive dialogue;
at least one list of associations between an equipment identifier and a behavior identifier.

23. Computer equipment item as claimed in claim 22, wherein said item also comprises a security processor and means for authenticating any computer equipment item considered for executing an interactive dialogue with said computer equipment item.

24. Computer equipment item as claimed in claim 22, wherein said item comprises means for processing the following lists: a list of equipment identifiers, a list of behavior identifiers and a list of associations between an equipment identifier and a behavior identifier.
